(19) United States
(12) Patent Application Publication
(10) Pub. No.: US 2020/0090244 A1
(43) Pub. Date: Mar. 19, 2020

(54) VEHICLE INVENTORY AVAILABILITY NOTIFICATION

(71) Applicant: CARS.COM, LLC, Chicago, IL (US)

(72) Inventors: Addhyan Pandey, Chicago, IL (US); Sandeep Kandekar, Aurora, IL (US); Krishna Anisetty, Chicago, IL (US); Alicia A. Nevels, Carol Stream, IL (US); Sunita Negi, Chicago, IL (US); Salin Thomas, Prospect Heights, IL (US); Srilakshmi Rayapeddi, Schaumburg, IL (US); Nikhil Patel, Chicago, IL (US); Chirag S. Patel, Naperville, IL (US); David Matthew Krell, Naperville, IL (US); Ramesh Jankampet, Aurora, IL (US); Audrey Salerno, Chicago, IL (US); Jennifer Wylie, Elmhurst, IL (US)

(21) Appl. No.: 16/133,482

(22) Filed: Sep. 17, 2018

(51) Int. Cl. G06Q 30/06; G06Q 10/06

(52) U.S. Cl. CPC G06Q 30/0623; G06Q 10/06315

(57) ABSTRACT

Systems and methods for providing information regarding vehicle inventory availability to users of an information system are disclosed. When generating a vehicle data page for a particular vehicle at a particular location, the information system may generate an expected duration of availability of the vehicle as a prediction of the time between listing and sale of the vehicle. When the expected duration of availability is below a threshold, a status indicator may be generated and added to the vehicle data page to alert users that the vehicle is expected to remain available for only a short period of time. An estimate of time remaining for the vehicle may also be generated and presented to users as part of the vehicle data page.

### TECHNICAL FIELD

The present disclosure generally relates to systems and methods for alerting users of electronic vehicle listing services to information regarding the expected duration of availability of uniquely identifiable vehicles at specifically identified locations.

### BACKGROUND

Vehicles and other unique products present a particular challenge for buyers and sellers inventory is not interchangeable. While this problem is particularly acute for used cars, even new cars typically differ in at least in location or some features (e.g., interior or exterior color, transmission type, utility packages, or entertainment features). It is rare for a vehicle dealer to have identical vehicles available for sale at the same dealer lot at the same time. Thus, each vehicle offered for sale by a vehicle dealer or another seller may be considered to be a unique product that combines various aspects of the vehicle, its location, and its history. This uniqueness of each vehicle offered for sale creates problems that do not arise in most sales contexts, where products are fungible or easily transported. For example, a book sold online can be any one of a plurality of identical copies of the book. Even if the book is a rare first edition, its size makes it possible to ship the book great distances without significantly changing the price or characteristics of the book. In contrast, shipping a vehicle adds significantly to the cost, whereas driving the vehicle to a buyer changes a key characteristic of the vehicle, viz. its mileage.

Because of the uniqueness of each vehicle, many consumers use electronic vehicle listing services to obtain information about vehicles currently available for sale. While these services enable users to research currently available vehicles in a relevant area, vehicles with desired characteristics may be unavailable for periods of time as inventory changes over time. Thus, users are often frustrated by spending time researching a particular vehicle, only to find the vehicle has been sold before they make a purchase decision. Although some uncertainty is inherent in the process, limited information available to users significantly contributes to the problem. Users are unable to determine when a vehicle was originally listed or when a listing was updated to make the vehicle more appealing to buyers, such as when a price is reduced. Additionally, total time from listing to sale varies across vehicle types and locations. Users of electronic vehicle listing services lack such information regarding vehicles offered for sale, resulting in inefficient use of such services and user frustration.

### SUMMARY

The present application discloses a method, system, and computer-readable medium storing instructions for providing information regarding vehicle inventory availability to users. Such techniques solve the problems associated with the lack of information by users of electronic vehicle listing services and similar information systems. The method, system, or instructions may include receiving a page generation request from a first user to post a vehicle page providing vehicle information regarding a uniquely identifiable vehicle for sale; generating an expected duration of availability of the uniquely identifiable vehicle by applying a predictive model to the vehicle information; determining a threshold duration based upon the vehicle information; determining that the expected duration of availability is below the threshold duration; generating the vehicle page including the vehicle information and a status indicator associated with the expected duration of availability; receiving a page display request from a second user to obtain the vehicle page; and transmitting the vehicle page for presentation to the second user. The page generation request from the first user to post the vehicle page may be a request to adjust at least part of corresponding vehicle information regarding the uniquely identifiable vehicle in a previously posted vehicle page.

The vehicle information may include vehicle characteristics of the uniquely identifiable vehicle and a location of the uniquely identifiable vehicle. The vehicle characteristics may include one or more of the following regarding the uniquely identifiable vehicle: a vehicle model, a year of manufacture, a plurality of optional vehicle features, or a price. The vehicle characteristics may likewise include a mileage or condition of the vehicle.

The expected duration of availability may indicate a total predicted time between the page generation request and a sale of the uniquely identifiable vehicle. The threshold duration may be either a new vehicle threshold duration associated with new vehicles or a used vehicle threshold duration associated with used vehicles. The new vehicle threshold duration may be three weeks, and the used vehicle threshold duration may be one week.

In some embodiments, the method, system, or instructions may further include determining a posting date on which the page generation request was received; determining a current date on which the page display request is received; and generating an estimate of time remaining. The status indicator may include the estimate of time remaining. Such estimate of time remaining may be determined as the difference between (i) an expected sale date determined based upon the posting date and the expected duration of availability and (ii) the current date. In additional embodiments, the method, system, or instructions may include determining an elapsed time since the posting date exceeds the expected duration of availability; adjusting the vehicle page to remove the status indicator; receiving an additional page display request from a third user to obtain the vehicle page; and transmitting the adjusted vehicle page for presentation to the third user, without the status indicator.

In further embodiments, the method, system, or instructions may further include generating the predictive model by receiving vehicle inventory data for a plurality of vehicles; receiving an untrained model configured to predict duration of availability; and training the untrained model using the vehicle inventor data to generate the predictive model. The vehicle inventory data may include one or more of the following for each vehicle of the plurality of vehicles: a location of the vehicle, a plurality of characteristics of the vehicle, a price of the vehicle, a listing date of the vehicle, or a sale date of the vehicle. The listing date of the vehicle may be a most recent date on which a listing for the vehicle was posted or updated, and the sale date of the vehicle may be a date on which the vehicle is inferred to have been sold based upon removal of the listing for the vehicle.

In various embodiments, additional, fewer, or alternate actions may be included or performed by the method, system, and computer-readable medium, including those discussed elsewhere herein.

### BRIEF DESCRIPTION OF THE DRAWINGS

The figures described below depict various aspects of the applications, methods, and systems disclosed herein. It should be understood that each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates a block diagram of an exemplary data system on which the methods described herein may operate in accordance with the embodiments described herein;

FIG. 2 illustrates a block diagram of an exemplary computing device in accordance with the embodiments described herein;

FIG. 3 illustrates a flow diagram of an exemplary predictive model generation method for training a model of expected duration of vehicle availability;

FIG. 4 illustrates a flow diagram of an exemplary vehicle page generation method for generating a vehicle page based upon expected duration of vehicle availability;

FIG. 5 illustrates a flow diagram of an exemplary vehicle page display method for determining and sending a vehicle page to a user device; and

FIGS. 6A-B illustrate exemplary vehicle pages having status indicators associated with expected duration of vehicle availability.

### DETAILED DESCRIPTION

The invention described herein is related to methods and systems for providing information regarding vehicle inventory availability to users of an information system. Specifically, the disclosure involves determination and presentation of estimates of duration of availability of particular (i.e., uniquely identifiable) vehicles offered for sale, based upon vehicle information regarding such vehicles and offers. Such estimates or predictions of availability of a vehicle may be generated and provided to users of an information system, such as an electronic vehicle listing service, to improve the usability of such system for the users by enabling the users to make more fully informed decisions. The expected duration of availability of a vehicle offered for sale may be evaluated to determine whether the vehicle is expected to sell faster than most similar vehicles, thus being available for a shorter period of time. Based upon such determination, a status indicator may be presented to a user to indicate a short expected duration of availability, which status indicator may be included in a vehicle page of the information system, along with salient vehicle information.

As used herein, the term “duration of availability” of a vehicle or other particularly identified object means a total time duration between the time an indication of availability of the object for sale is initially generated and a time of sale or inferred sale of the object. A modification of the characteristics included in the indication of availability may constitute initial generation of a new indication of availability, even when such modification is implemented by partially updating an existing record within a dataset. By modifying a location, feature, price, or other relevant characteristic associated with the vehicle or other particularly identified object, the indication of availability may be fundamentally altered. For example, shipping a vehicle from Chicago to New Orleans fundamentally alters the characteristics of the indication of availability. Price changes or mileage changes for a vehicle may have similar effects. Thus, in some embodiments, every change to a vehicle location or vehicle characteristic may be considered an initial generation of a new indication of availability. Additionally, as used herein, the term “expected duration of availability” of a vehicle or other particularly identified object means a predicted duration of availability based upon information regarding the vehicle or other particularly identified object.

Although described herein with respect to vehicles, the methods disclosed could be applied to other uniquely identifiable objects. Most vehicles are uniquely identifiable based upon a Vehicle Identification Number (VIN), manufacturer serial number, or a combination of other information that uniquely identifies a particular vehicle. Other objects may be similarly uniquely identified, such as by serial number. Frequently, the features, condition, and location of a vehicle or other object may be sufficient to uniquely identify such object.

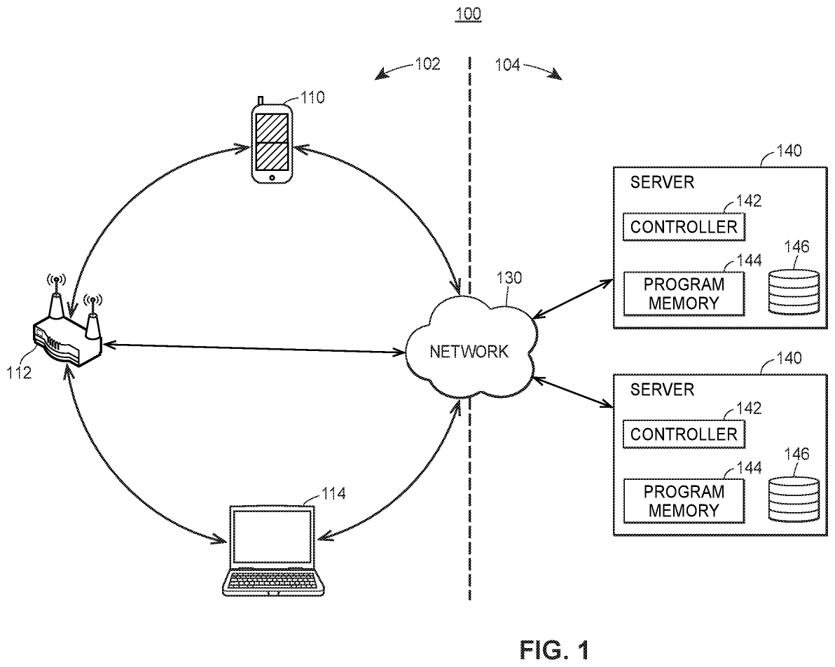

FIG. 1 illustrates a block diagram of an exemplary data system 100. The high-level architecture includes both hardware and software applications, as well as various data communications channels for communicating data between the various hardware and software components. The data system 100 may be roughly divided into front-end components 102 and back-end components 104. The front-end components 102 may communicate via a network 130 with the back-end components 104, as well as with other front-end components 102. For example, the front-end components 102 may include a plurality of computing systems communicatively connected to the back-end components 104 via the network 130. As illustrated, the computing systems may include one or more client computing devices 110 associated with a user (e.g., a smartphone or home computer of a vehicle buyer) and one or more dealer computing device 114 associated with a vehicle dealer or other seller (e.g., a desktop computer, notebook, or tablet computer). The client computing device 110 may be used by a user to request and obtain data using one or more software programs, which data may include information regarding available vehicles or vehicle dealers. The dealer computing device 114 may be used by an operator associated with a vehicle dealer or other seller to provide information regarding one or more vehicles available for sale, which may be stored as vehicle pages or other listings by one or more servers 140 for presentation to potential buyers associated with client computing devices 110. In some embodiments, the client computing devices 110 or the dealer computing devices 114 may communicate with one or more routers 112 to exchange data with each other or with the back-end components 104. Although one client computing device 110, one router 112, and one dealer computing device 114 are shown, it should be understood that the data system 100 may include a plurality of each or any of such components (e.g., hundreds or thousands of such devices). Any of the front-end components 102 may be directly or indirectly (e.g., through a router 112) connected to the network 130.

The back-end components 104 may operate in coordination with the front-end components 102 to communicate, process, generate, and store data. To this end, the back-end components 104 may include a server 140 that stores data received from the front-end components 102 via the network 130. The server 140 may further provide requested data to the front-end components 102, such as vehicle data. In some embodiments, the back-end components 104 may include a plurality of servers 140 performing distinct or overlapping functions. For example, a first server 140 may perform model generation or parameter prediction functions, while a second server 140 may store and present vehicle listing data to users. Alternatively, one server 140 may perform any or all of the functions described herein. Each server 140 may include a controller 142 to process data and run software programs, applications, or routines stored in a program memory 144 as executable instructions, and the server 140 may further include or be communicatively connected to a database 146 for data storage and retrieval.

The front-end components 102 may be arranged in various configurations including varying components. In some embodiments, the front-end components 104 may include a plurality of client computing devices 110 configured to access information from the server 140 via the network 130 and to communicate information to the server 140. In an exemplary embodiment described in detail herein, the front-end components 102 and back-end components 104 may be used to facilitate listing and viewing of vehicles available for sale, which may include a dealer or other seller posting a vehicle page by providing information to a server 140 from a dealer computing device 114, as well as a buyer viewing such vehicle page by requesting information from the server 140 by communication from a client computing device 110. Each of the client computing devices 110 and the dealer computing devices 114 may send and receive data associated with vehicles by executing general-purpose or special-purpose software application running on the devices, such as from a web browser, a data service application, or a messaging application (e.g., via an automated or live communication session). The client computing devices 110 may obtain data regarding a specific vehicle via the network 130 from a server 140, which server 140 may store vehicle information regarding a plurality of vehicles. The server 140 may further acquire and store information regarding available vehicles, based upon data received from the dealer computing devices 114. Such data may include vehicle location, price, and various vehicle characteristics (e.g., make, model, year, mileage, color, trim, or optional features). The server 140 may generate vehicle pages based upon such information, which may include expected duration of availability of vehicles, as discussed further below.

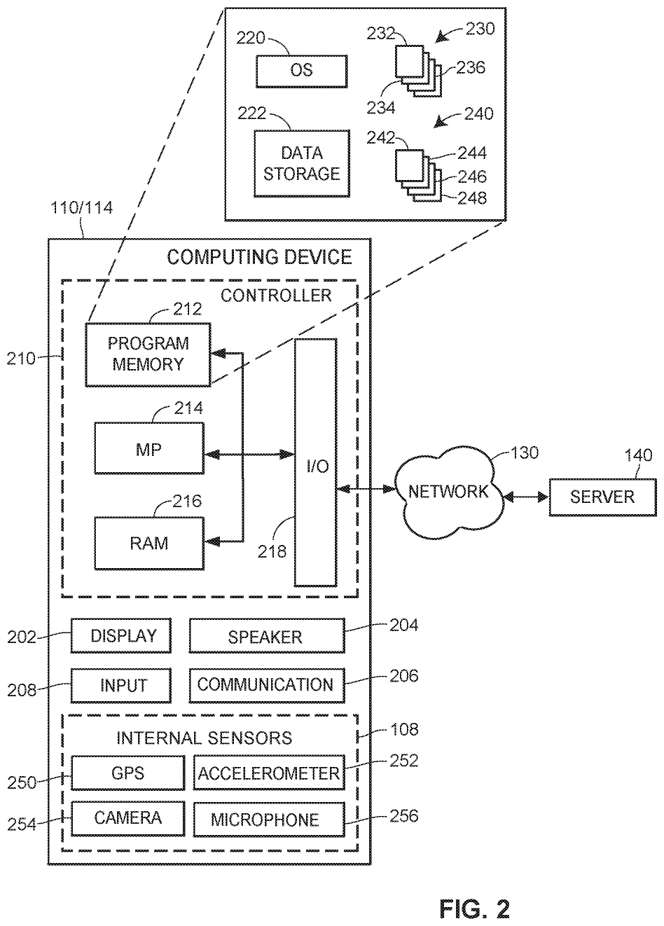

In various embodiments, the client computing devices 110 or dealer computing devices 114 may be any known or later-developed dedicated-use or general-use mobile personal computers, cellular phones, smartphones, tablet computers, or wearable computing devices (e.g., watches, glasses, etc.). For example, the client computing device 110 may be a general use smartphone or tablet computer with a web browser. In some embodiments, the client computing device 110 may be a thin client device, wherein much or all of the computing processes are performed by the server 140, with information communicated between the thin client device and the server 140 via the network 130. The client computing device 110 may include any number of internal components and may be further communicatively connected to one or more external components by any known wired or wireless means (e.g., USB cables, Bluetooth communication, etc.). An embodiment of the client computing device 110 and dealer computing device 114 is further discussed below with respect to FIG. 2.

One or more routers 112 may be included within the data system 100 to facilitate communication. The routers 112 may be any wired, wireless, or combination wired/wireless routers using any known or here-after developed communication protocol for general- or special-purpose computer communication. In some embodiments, the client computing devices 110 or dealer computing devices 114 may be communicatively connected to the network 130 via one or more routers 112. Wireless communication may occur by any known means, such as Bluetooth, Wi-Fi, or other appropriate radio-frequency or other communications protocols.

The front-end components 102 communicate with the back-end components 104 via the network 130. The network 130 may be a proprietary network, a secure public internet, a virtual private network or some other type of network, such as dedicated access lines, plain ordinary telephone lines, satellite links, cellular data networks, combinations of these, etc. Where the network 130 comprises the Internet, data communications may take place over the network 130 via an Internet communication protocol.

The back-end components 104 include one or more servers 140. Each server 140 may include one or more computer processors within the controller 142 adapted and configured to execute various software applications and routines of the data system 100 stored in the program memory 144 of the server 140, in addition to other software applications. The controller 142 may include or be connected to one or more processors (not shown), a random-access memory (RAM) (not shown), the program memory 144, and an input/output (I/O) circuit (not shown), all of which may be interconnected via an address/data bus (not shown). The RAM and program memory 144 may be implemented as semiconductor memories, magnetically readable memories, optically readable memories, or any other type of known or hereafter developed memory capable of storing executable instructions for execution by computer processors, such as the controller 142. The server 140 may further include one or more databases 146, which may be adapted to store data received from the front-end components 102, as well as data to be transmitted to the front-end components 102 (e.g., vehicle or vehicle dealer information). Such data might include, for example, information regarding vehicles listed for sale by vehicle dealers, information regarding average prices or ratings for vehicles of specified types, makes, models, or years, information regarding vehicle dealer inventory, hours, or customer ratings, or other information a customer may use in searching for or purchasing a vehicle. The server 140 may access data stored in the database 146 when executing various functions and tasks associated with the data system 100. Although referred to herein as a single database 146, multiple databases may be used in some embodiments, each of which may be relational or non-relational.

FIG. 2 illustrates a block diagram of an exemplary client computing device 110 or dealer computing device 114 in accordance with the data system 100. Any client computer device 110 or dealer computing device 114 may, in some embodiments, include additional or fewer components than the exemplary device illustrated in FIG. 2. Although the following description refers to the client computing device 110 for simplicity and clarity, it should be understood that any combination of features described herein with respect to the client computing device 110 may be included in the dealer computing device 114.

The client computing device 110 may be a desktop computer, a notebook computer, a netbook computer, a smartphone, a tablet computer, or similar mobile or stationary computing device capable of receiving and processing electronic information. In some embodiments, the client computing device 110 may include a wearable computing device or may be communicatively connected to a wearable computing device. The client computing device 110 may include one or more internal sensors 108, which may provide sensor data regarding the local physical environment or the device's location therein. Such internal sensors 108 may likewise facilitate user input to the client computing device 110, such as by enabling the user to issue voice commands via a microphone 256. The client computing device 110 may further communicate with the server 140 via the router 112 and/or the network 130 to send and receive data. The data may be processed by the controller 210 to perform various operations for the user. Additionally, or alternatively, the data may be sent to one or more processors of the server 140 through the network 130 for processing. When the controller 210 (or other processor) receives an indication of a user action or request, appropriate responses are determined and implemented. Such responses may include processing data for presentation to the user, requesting data from the server 140, processing data from other front-end components 102 or back end components 104, determining information regarding the client computing device 110, sending data to the server 140, or presenting information to the user via a display 202 or speaker 204. In some embodiments, the client computing device 110 may include a communication unit 206 to send or receive information from local or remote devices (e.g., server 140), either directly or through the network 130. The communication unit 206 may include a wireless communication transceiver, such as a Wi-Fi or Bluetooth communication component. Further embodiments of the client computing device 110 may include one or more inputs 208 to receive instructions, selections, or other information from a user of the client computing device 110.

The client computing device 110 may include various input and output components, units, or devices. The display 202 and speaker 204, along with other integrated or communicatively connected output devices (not shown), may be used to present information to the user of the client computing device 110 or others. The display 202 may include any known or hereafter developed visual or tactile display technology, including LCD, OLED, AMOLED, projection displays, refreshable braille displays, haptic displays, or other types of displays. The one or more speakers 204 may similarly include any controllable audible output device or component, which may include a haptic component or device. In some embodiments, communicatively connected speakers 204 may be used (e.g., headphones, Bluetooth headsets, docking stations with additional speakers, etc.). The input 208 may further receive information from the user. Such input 208 may include a physical or virtual keyboard, a microphone, virtual or physical buttons or dials, or other means of receiving information. In some embodiments, the display 202 may include a touch screen or otherwise be configured to receive input from a user, in which case the display 202 and the input 208 may be combined.

The client computing device 110 may further include various internal sensors 108. The internal sensors 108 may include any devices or components mentioned herein, other extant or later-developed devices suitable for monitoring a physical environment, including device position or location within the environment. The sensors of the client computing device 110 may further include additional internal sensors 108 specifically configured for determining location or for tracking movement or spatial orientation of the device.

Although discussion of all possible sensors of the client computing device 110 would be impractical, if not impossible, several sensors warrant particular discussion. Disposed within the client computing device 110, the internal sensors 108 may include a GPS unit 250, an accelerometer 252, a camera 254, or a microphone 256. Any or all of these may be used to generate sensor data regarding the client computing device 110, its environment, user activity, or other relevant information. Additionally, other types of currently available or later-developed sensors may be included in some embodiments.

The GPS unit 250 or the accelerometer 252 may provide information regarding the location or movement of the client computing device 110. The GPS unit 250 may use “Assisted GPS” (A-GPS), satellite GPS, or any other suitable global positioning protocol (e.g., the GLONASS system operated by the Russian government) or system that locates the position of the client computing device 110. The accelerometer 252 may include one or more accelerometers positioned to determine the force and direction of movements of the client computing device 110.

The camera 254 may be used to capture images of vehicles or other relevant objects in the user's environment. It should be understood that one or more cameras 254 may be disposed within the client computing device 110 and configured to generate either still images or video recordings. The microphone 256 may be used to monitor sounds within the local physical environment 106. The microphone 256 may be used to record sounds or to receive voice commands from a user.

The client computing device 110 may also communicate with the router 112 or the network 130 using the communication unit 206, which may manage communication between the controller 210 and external devices. The communication unit 206 may transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit 206 may also be capable of communicating using a near field communication standard (e.g., ISO/IEC 18092, standards provided by the NFC Forum, etc.). Furthermore, the communication unit 206 may provide input signals to the controller 210 via the I/O circuit 218. The communication unit 206 may also transmit sensor data, device status information, control signals, or other output from the controller 210 to one or more of the router 112, the network 130, or the server 140.

The client computing device 110 may further include a controller 210. The controller 210 may be configured to receive, process, produce, transmit, and store data. The controller 210 may include a program memory 212, one or more microcontrollers or microprocessors (MP) 214, a random access memory (RAM) 216, and an I/O circuit 218. The components of the controller 210 may be interconnected via an address/data bus or other means. It should be appreciated that although FIG. 2 depicts only one microprocessor 214, the controller 210 may include multiple microprocessors 214 in some embodiments. Similarly, the memory of the controller 210 may include multiple RAM 216 or multiple program memories 212. Although the FIG. 2 depicts the I/O circuit 218 as a single block, the I/O circuit 218 may include a number of different I/O circuits, which may be configured for specific I/O operations. The microprocessor 214 may include one or more processors of any known or hereafter developed type, including general-purpose processors or special-purpose processors. Similarly, the controller 210 may implement the RAM 216 and program memories 212 as semiconductor memories, magnetically readable memories, optically readable memories, or any other type of memory.

The program memory 212 may include an operating system 220, a data storage 222, a plurality of software applications 230, and a plurality of software routines 240. The operating system 220, for example, may include one of a plurality of mobile platforms such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage 222 may include data such as user profiles and preferences, application data for the plurality of applications 230, routine data for the plurality of routines 240, or other data related to interaction with the server 140 through the digital network 130. In some embodiments, the controller 210 may also include, or otherwise be communicatively connected to, other data storage mechanisms (e.g., one or more hard disk drives, optical storage drives, solid state storage devices, etc.) that reside within the client computing device 110. Moreover, in thin-client implementations, additional processing and data storage may be provided by the server 140 via the network 130.

The software applications 230 and routines 240 may include computer-readable instructions that cause the processor 214 to implement data processing and communication functions. Thus, the software applications 230 may include a vehicle information application 232 to obtain and present information regarding vehicles or vehicle dealers, a web browser application 234 to obtain and present web-based content, or a mapping application 236 to present visual maps based upon user parameters. The software routines 240 may support the software applications 230 and may include routines such as a location routine 242 to determine a location of the client computing device 110 from GPS or other data, a communication routine 244 for communicating with the server 140 via the network 130, a data request routine 246 to allow a user to specify parameters for requesting data, and a data presentation routine 248 for generating or presenting received data to the user via the display 202. It should be understood that additional or alternative applications 230 or routines 240 may be included in the program memory 212, including other applications of the sort ordinarily stored on mobile devices.

The data system 100 described above and illustrated in FIGS. 1-2 may be used to perform the various model generation and vehicle page generation and display methods discussed further below. Together, the methods described below relate to providing information to users of electronic information systems regarding expected availability of vehicles offered for sale. Such information regarding expected availability may be presented as a status indicator, which may include information regarding an estimate of time remaining. Although the methods are described with reference to vehicles, the methods may be applied to other uniquely identifiable objects.

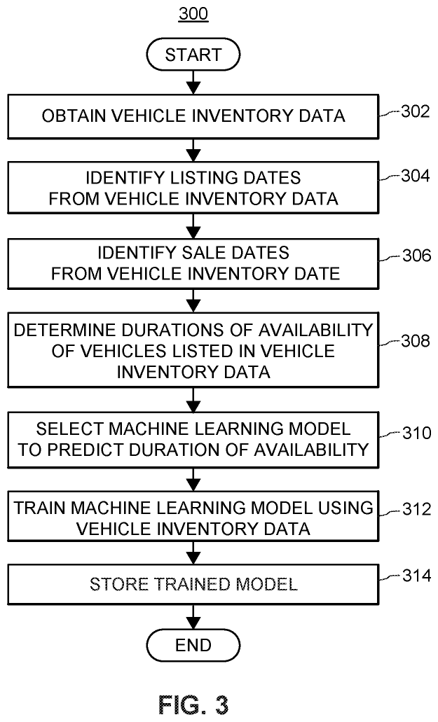

FIG. 3 illustrates a flow diagram of an exemplary predictive model generation method 300 for training a model of expected duration of vehicle availability. The model may be generated from data regarding duration of availability of a plurality of vehicles, such as duration of previous listings of such vehicles. Although predictive models may be generated by other techniques, the use of machine-learning techniques is particularly useful in identifying and evaluating salient parameters using large datasets. To generate a predictive model, the method 300 may thus train a machine-learning model using a dataset of vehicle inventory data for vehicles previously listed as available for sale. In some embodiments, such inventory data may be combined with other vehicle records or may be analyzed to infer sales of the vehicles. The predictive model generation method 300 may be implemented using one or more servers 140 using data stored in one or more databases 146. In some embodiments, the exemplary method 300 may be modified to include alternative, additional, or fewer actions.

The predictive model generation method 300 may begin by obtaining vehicle inventory data for a plurality of vehicles as training data (block 302). The vehicle inventory data may be processed to identify listing dates (block 304) and sale dates (block 306) for each vehicle in the dataset. From such dates, the duration of availability for each listing in the vehicle inventory may be determined (block 308). A machine-learning model may be selected (block 310), and the model may be trained using the vehicle inventory data and/or the data derived therefrom (block 312). The trained model may then be stored for future use (block 314).

At block 302, the server 140 may obtain vehicle inventory data from a database 146. The vehicle inventory data may include information for a plurality of vehicles previously sold, such as listings from a vehicle listings database. The inventory data may include relevant listing data for each vehicle, including the following: a location of the vehicle, a plurality of characteristics of the vehicle, a price of the vehicle, a listing date of the vehicle, and a sale date of the vehicle. In some instances, the same vehicle may be listed simultaneously in multiple locations (e.g., at affiliated vehicle dealer lots), which may be treated separately for purposes of determining vehicle availability, due to the differences in location. Additional data may be included in some embodiments, such as general economic data (e.g., GDP, unemployment, interest rate, or consumer sentiment data) or other data from external data sources. In some embodiments, the vehicle inventory data may be limited to a specific type or location of vehicle (e.g., a make and model, a metropolitan area, or a category of vehicle).

At block 304, the server 140 may identify a listing date for each vehicle in the vehicle inventory data. This may include identifying each unique vehicle or vehicle/location combination in the dataset, such as by VIN or otherwise matching records to account for duplicates or multiple listings. In some embodiments, only the most recent listing or update to a listing prior to a sale may be identified as a listing date. As each change to a listing may materially change the attractiveness of the listed vehicle (and, hence, the time the vehicle remains available before it is sold), updates or changes to listings may be treated as new listings, and previous listings for the same vehicle may be discarded. The listing date for a vehicle may be the date on which a vehicle dealer or other seller posted a vehicle page indicating the vehicle as available for sale.

At block 306, the server 140 may identify a sale date for each vehicle in the vehicle inventory data. Sale dates may be directly available in the vehicle inventory data or may be inferred from other information in the vehicle inventory data or external sources. Sale dates may be inferred based upon information such as a removal of a listing or a vehicle page. Because vehicles may be removed from the market for short periods of time for transfer to another dealer or location, inferred sale dates may be checked for quality by searching for additional listings of the same vehicle within a short time window (e.g., 30 days or 90 days). Since most purchasers do not sell vehicles within a short time window after a purchase, such relistings may be treated as part of the same listing. Thus, only the latter inferred sale date may be identified as a sale date, while any earlier putative sale dates may be discarded.

At block 308, the server 140 may determine the duration of availability of each vehicle listed in the vehicle inventory data. The duration of availability may be determined by calculating the difference between the identified sale date and the identified listing date for each vehicle in the dataset. The duration of availability may be stored for use in training the predictive model, along with the vehicle data from the most recent listing prior to the sale date of the corresponding vehicle. Once this data is prepared, it may be used to train a machine-learning model to predict duration of availability for similar vehicles.

At block 310, the server 140 may select a machine-learning model for predicting duration of availability based upon the corresponding vehicle data. Selecting the machine-learning model may include accessing or receiving a machine-learning model configured to predict the duration of availability for training using the prepared dataset. The model may comprise a structure of the explanatory and predicted variables, as well as a model type or training parameters (e.g., algorithm to employ, model size constrains, number of training iterations, or rules for the model).

At block 312, the server 140 may train the machine-learning model using the dataset derived from the vehicle inventory data. The machine-learning model may be trained using a supervised or unsupervised machine-learning program or algorithm. The machine-learning program or algorithm may employ a neural network, which may be a convolutional neural network, a deep learning neural network, or a combined learning module or program that learns in two or more features or feature datasets in a particular areas of interest. The machine-learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine-learning algorithms and/or techniques. The machine-learning model may be trained using a portion of the vehicle inventory data, then tested using another portion of the vehicle inventory data to verify the model. Training may continue until the trained model is verified as sufficiently accurate or until further training produces no further improvements to the model predictive power.

At block 314, the server 140 may store the trained model in the program memory 144 or database 146 for further use in predicting duration of availability for particular vehicles, as discussed further below.

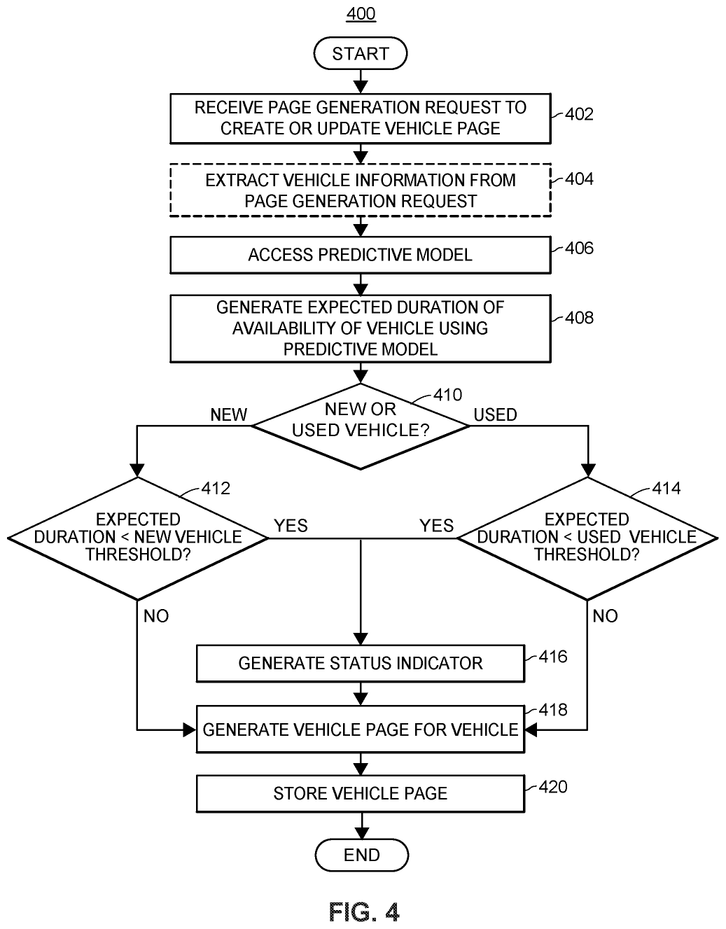

FIG. 4 illustrates a flow diagram of an exemplary vehicle page generation method 400 for generating a vehicle page based upon expected duration of vehicle availability. The method 400 may use a stored predictive model generated by the predictive model generation method 300, as discussed above, in order to determine an expected duration of availability for a vehicle. When the expected duration of availability meets certain criteria, a status indicator may be generated for the vehicle to indicate how long the vehicle is expected to be available before being sold. A vehicle page including information regarding the vehicle may then be generated, which may include the status indicator in appropriate instances. Such vehicle pages may include electronic listings of new or used vehicles offered for sale, providing relevant information to potential buyers. The vehicle page generation method 400 may be implemented using one or more servers 140. In some embodiments, the exemplary method 400 may be modified to include alternative, additional, or fewer actions.

The vehicle page generation method 400 may begin upon receiving a page generation request to create or update a vehicle page associated with a vehicle (block 402). In some embodiments, vehicle information may be extracted from the page generation request (block 404). A predictive model of expected duration of availability may then be accessed (block 406) and used to generate the expected duration of availability for the vehicle based upon the vehicle information (block 408). The vehicle may be determined to be either a new vehicle or a used vehicle (block 410). Based upon such determination, the expected duration of availability may be compared against a new vehicle threshold (block 414) or a used vehicle threshold (block 414). When the expected duration of availability is shorter than the applicable threshold duration, a status indicator may be generated to indicate the short expected duration of availability (block 416). Regardless of the expected duration of availability, the vehicle page for the vehicle may then be generated (block 418), with or without the status indicator as appropriate. The vehicle page 420 may then be stored for later use (block 420).

At block 402, the server 140 may receive a page generation request from a dealer computing device 114 via network 130, which includes a request to create a new vehicle page or update a portion of an existing vehicle page. The page generation request may include vehicle information for posting in a new vehicle page or for updating an existing vehicle page by adjusting at least part of the information in a previously posted vehicle page for the same vehicle. Such vehicle information may include details regarding a particular (i.e., uniquely identifiable) vehicle, such as a specific new or used vehicle being offered for sale at a certain location (e.g., a listing of a particular vehicle at a specific vehicle dealer lot). The vehicle information may thus include details such as a location of the vehicle (e.g., a dealership or seller location) and various vehicle characteristics providing relevant information regarding the vehicle or the offer for sale. Such vehicle characteristics may include a vehicle model, year of manufacture, vehicle mileage, a plurality of optional vehicle features (e.g., interior or exterior color, drivetrain, transmission, engine, entertainment features, or safety features), a price at which the vehicle is listed for sale, or other similar aspects of a vehicle or listing. The page generation request may include submission of a web-based form, transmission of a web page, or transmission of another file containing vehicle information from which the vehicle page can be generated or updated.

At block 404, in some embodiments, the server 140 may extract the vehicle information described above from the page generation request upon receipt of such request. Such vehicle information extraction may occur if the page generation request comprises a file containing the information, such as a text file transmitted via the network 130. Extraction of data fields from formatted data files is well known in the art. In some embodiments, extracting the vehicle information from the page generation request may include comparing information in a request to update a vehicle page against information of the current vehicle page to identify changes to be made to the vehicle page.

At block 406, the server 140 may access a predictive model for predicting duration of availability of vehicles based upon vehicle information. Such predictive model may include a model trained using machine-learning techniques, as described above. Alternatively, the predictive model may be an analyst-specified model generated based upon similar vehicle inventory data. The server 140 may access the predictive model from a program memory 144 or database 146. In some embodiments, the predictive model may be specific to a make or model of vehicle, which may further be divided by year or geographic market (e.g., state or metropolitan area). In some such embodiments, the predictive model may be generated for a particular group of vehicles (e.g., make/model/year/market) in response to receiving the page generation request if such model has not previously been generated.

At block 408, the server 140 may generate an expected duration of availability of the vehicle identified by the page generation request. To generate the expected duration of availability of the vehicle from the time of the page generation request until a time of sale, the server 140 may apply the predictive model to the vehicle information regarding the vehicle. The server 140 may thus calculate the expected duration of availability of the particular vehicle using the predictive model and the vehicle information. In some embodiments, the server 140 may perform preprocessing or postproscessing to obtain a more accurate estimate of duration of availability. For example, preprocessing may include verifying the vehicle information or retrieving additional vehicle information from a database 146, which additional vehicle data may include vehicle information from an existing vehicle page associated with the vehicle (e.g., to supplement updated vehicle information with other vehicle information not being updated). Postprocessing may include verifying the predicted value of the duration of availability generated by the predictive model, such as by comparing the value to a range of expected values (e.g., 060 days). The expected duration of availability of the vehicle may likewise be rounded to an integer number of days.

At block 410, the server 140 may determine whether the particular vehicle identified by the page generation request is a new vehicle or a used vehicle. Such distinction may be significant because new vehicle typically take substantially longer to sell than used vehicles. Thus, whether a vehicle is expected to be available for only a short time may depend upon whether a certain length of time is considered shorter than the ordinary duration of availability. When the vehicle is determined to be a new vehicle, the expected duration of availability may be compared to a new vehicle threshold at block 412. When the vehicle is instead determined to be a used vehicle, the expected duration of availability may be compared to a used vehicle threshold at block 414. The server 140 may determine the appropriate threshold duration based upon whether the vehicle is a new vehicle or a used vehicle.

At block 412, when the vehicle is a new vehicle, the server 140 may determine whether the expected duration of availability of the vehicle is below a new vehicle threshold. Such new vehicle threshold may be a generally applicable threshold duration for new vehicles generally, or it may be a variable threshold duration for a subset of new vehicles. For example, a variable new vehicle threshold may be determined by the server 140 based upon a geographic area associated with the vehicle, a vehicle type or category (e.g., sedan, light truck, SUV, economy, or luxury), or a price range. For a generally applicable new vehicle threshold, a threshold duration of three weeks is particularly effective for identifying fast-selling new cars, though other threshold durations may be used.

At block 414, when the vehicle is a used vehicle, the server 140 may determine whether the expected duration of availability of the vehicle is below a used vehicle threshold. As with the new vehicle threshold, the used vehicle threshold may be either a generally applicable threshold duration or a variable threshold duration for a subset of used vehicles. For a generally applicable used vehicle threshold, a threshold duration of one week is particularly effective for identifying fast-selling used cars, though other threshold durations may be used.

When the expected duration of availability of the vehicle is determined to be below the appropriate threshold duration (i.e., the new vehicle threshold for a new vehicle or the used vehicle threshold for a used vehicle) at block 412 or block 414, the server 140 may generate a status indicator for the vehicle page at block 416. Otherwise, the server 140 may proceed to generate the vehicle page for the vehicle (without a status indicator) at block 418.

At block 416, the server 140 may generate a status indicator associated with the vehicle based upon the expected duration of availability. The status indicator—or a visual representation thereof—may be added to the vehicle page to provide information regarding the expected duration of availability of the vehicle. Such status indicator may indicate the vehicle is expected to sell faster than average for vehicles of the relevant type (e.g., other all new vehicles or all used vehicles), or the status indicator may indicate how long the vehicle is expected to be available before it is sold. For example, the status indicator may indicate a time at which the vehicle is expected to be sold with a specified probability (e.g., a date by which the vehicle has a 70% probability of being sold).

At block 418, the server 140 may generate the vehicle page requested by the page generation request—with or without a status generator, as appropriate. The vehicle page may be generated to create a new vehicle page for presenting the vehicle information to users, or the vehicle page may be generated to update an existing vehicle page to include updated vehicle information. When a status indicator has been generated for the vehicle at block 416, the vehicle page includes the status indicator. In some embodiments, the vehicle page may also include the expected duration of availability. The vehicle page may be generated as a web page configured for presentation to a user via a web browser, an application page configured for presentation to a user via a custom application, or an entry within a data management system for population within a template (e.g., an entry comprising values in a plurality of data fields representing a listing of the vehicle within a vehicle listings database).

At block 520, the server 140 may store the vehicle page in a program memory 144 or database 146 for later use. The vehicle page may be stored as one or more files, one or more entries within a database, or a combination thereof. For example, the vehicle page may be stored as a record representing a vehicle listing for the vehicle in a vehicle listings database, which record may include references to additional tables in the database or image files storing electronic photographs of the vehicle. Upon storing the vehicle page, the method 400 may terminate.

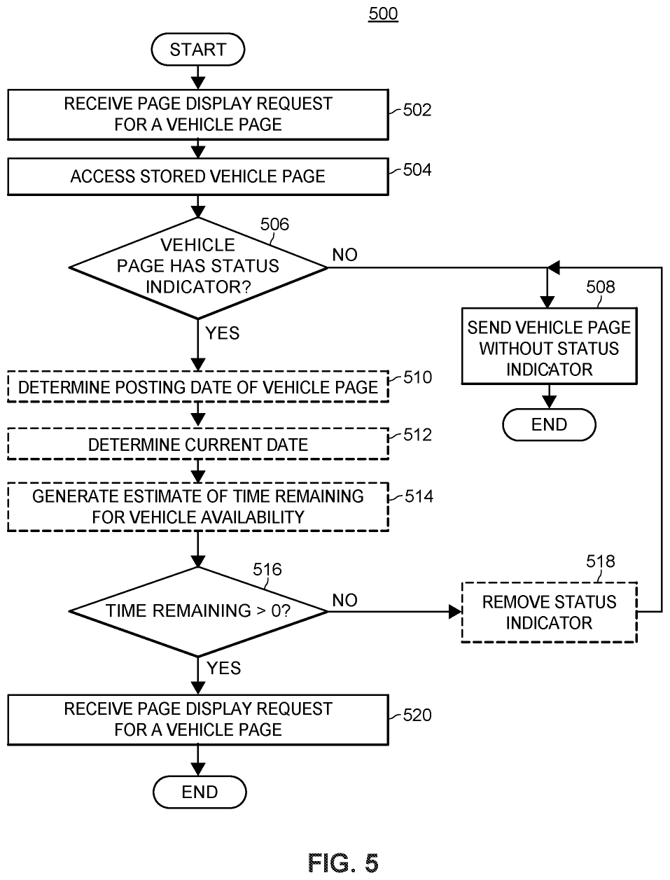

FIG. 5 illustrates a flow diagram of an exemplary vehicle page display method 500 for determining and sending a vehicle page to a user device. The method 500 may be implemented to access and send a stored vehicle page that has been generated by the vehicle page generation method 400, as described above. In some embodiments, the method 500 may include updating a portion of the vehicle page to provide current information, such as an estimate of time remaining for availability of a vehicle. The vehicle page display method 500 may be implemented using one or more servers 140. In some embodiments, the exemplary method 500 may be modified to include alternative, additional, or fewer actions.

The vehicle page display method 500 may begin upon receiving a page display request to send a vehicle page associated with a particular vehicle (block 502). In response to the page display request, a stored vehicle page may be accessed (block 504). The accessed vehicle page may then be evaluated to determine whether it includes a status indicator for the vehicle (block 506). If no status indicator is identified, the vehicle page may be sent to the requesting user device without the status indicator (block 508). If a status indicator is identified, however, the vehicle page may be further updated in some embodiments. In such embodiments, the posting date of the vehicle page (block 510) and the current date (block 512) may be determined and used to generate an estimate of time remaining for the vehicle (block 514). In further embodiments, the estimated of time remaining may be checked to determine whether any time is remaining (block 516), and the status indicator may be removed if no time is estimated to remain (block 518) before sending the vehicle page to the user device without the status indicator (block 508). Otherwise, the method may conclude with sending the requested vehicle page with the status indicator and/or the estimate of time remaining to the requesting user device (block 520).

At block 502, the server 140 may receive a page display request from a user device, such as a client computing device 110 via network 130. The page display request may identify a listing of a particular (i.e., uniquely identifiable) vehicle at a specific location or a particular vehicle page associated with the particular vehicle. For example, the page display request may be received from a web browser application 234 running on a client computing device 110 when the user selects a link to open a vehicle page of a web site, in which case the page display request may be a request to a web server to provide a page identified by a URL. As another example, the page display request may be received from a custom application running on a client computing device 110 when the user operates the application to display information regarding one or more particular vehicles.

At block 504, the server 140 may access a stored vehicle page in response to the page display request. Such vehicle page may be a vehicle page generated by the method 400, as described above. Accessing the stored vehicle page may include accessing one or more files, as well as accessing one or more entries within a database.

At block 506, the server 140 may determine whether the vehicle page includes a status indicator for the vehicle. When the vehicle page does not include a status indicator, the server 140 may proceed to send the vehicle page associated with the particular vehicle to the user (without a status indicator) at block 508. When the vehicle page does include a status indicator, however, the server 140 may proceed to send the vehicle page (with the status indicator or a related indicator) to the user at block 520. In some embodiments, when the vehicle does include a status indicator, the server 140 may first determine the estimated time remaining for the expected duration of availability associated with the status indicator at blocks 510-516.

At block 508, the server 140 may send the vehicle page without a status indicator when no status indicator is included in the vehicle page. The server 140 may thus transmit the vehicle page via the network 130 to the client computing device 110. In some embodiments, this may include generating a displayable vehicle page from the vehicle information included in the stored vehicle page. Such displayable vehicle page may include the vehicle information from the stored vehicle page in a format for transmission to and display at the client computing device 110. Upon sending the vehicle page to the client computing device 110, the method 500 may terminate.

At blocks 510-514, in some embodiments, the server 140 may calculate an estimated time remaining during which the vehicle is expected to be available. At block 510, the server 140 may determine a posting date of the vehicle page. Such posting date may be the date a page generate request was received or a later date when the vehicle page was first posted, in the case of a delay. At block 512, the server 140 may further determine a current date on which the page display request was received. The posting date and the current date may be held in volatile memory of the server 140 for further use in estimating the time remaining for the vehicle. At block 514, the server 140 may use the posting date, the current date to generate an estimate of time remaining for vehicle availability. Generating the estimate of time remaining may include determining an expected sale date, which may be directly indicated by the status indicator or may be calculated based upon the posting date and the expected duration of availability indicated by the status indicator. In some embodiments, the expected sale date or the expected duration of availability may be stored separately from the status indicator, in which case the server 140 may access such information in order to generate the estimate of time remaining. Once the expected sale date has been obtained, the server 140 may calculate the estimate of time remaining as the difference between the expected sale date and the current date. The estimate of time remaining may then be included in the vehicle page or as part of the status indicator when the vehicle page is sent to the user.

At block 516, in some embodiments, the server 140 may determine whether any time remains before the expected sale of the vehicle based upon the expected duration of availability. Where an estimate of time remaining has been generated, the server 140 may make such determination by determining whether the estimate of time remaining is greater than zero (i.e., at least one day remains). Alternatively, such determination may be made by determining whether the time remaining is at least zero, thereby including the expected sale date as a day when the vehicle is expected to remain available. Other thresholds may similarly be used (e.g., negative numbers indicating a limited number of days after the expected sale date). Alternatively, the server 140 may determine whether any time remains before the expected sale of the vehicle by determining an elapsed time since the posting date by calculating the difference between the current date and the posting date, which may then be compared against the expected duration of availability to determine whether any time is remaining (i.e., whether the expected duration of availability of the vehicle exceeds the elapsed time). However determined, if the server 140 determines that time remains before the expected sale of the vehicle, the vehicle page may be sent at block 520. If the server 140 determines that no time remains before the expected sale of the vehicle, the vehicle page may be updated to remove the status indicator at block 518.

At block 518, the server 140 may adjust the vehicle page to remove the status indicator. This may include setting a value of a field in a record representing the vehicle page in a vehicle listings database to a value associated with absence of a status indicator, or this may include generating a new vehicle page without the status indicator as a replacement for the existing vehicle page without the status indicator (without triggering an update to the vehicle page as a new or updated listing). Thus, the vehicle page may be adjusted to remove the status indicator, such that the vehicle page will be determined not to have a status indicator at block 506 in response to future page display requests. Once the status indicator has been removed from the vehicle page at block 518, the server 140 may proceed to send the vehicle page without a status indicator when no status indicator is included in the vehicle page at block 508, as discussed above.

At block 520, the server 140 may send the vehicle page with the status indicator, estimate of time remaining, or both to the client computing device 110 for presentation to the user in response to the page display request. The server 140 may thus transmit the vehicle page via the network 130 to the client computing device 110. Prior to transmission, the server 140 may add the estimate of time remaining or a representation thereof, which may include text or image data. In some embodiments, the server 140 may adjust the status indicator based upon the estimate of time remaining, in order to better indicate to the user how much longer the vehicle is likely to remain available. For example, text or images associated with the status indicator may be adjusted when the estimated time remaining is below a short-duration threshold (e.g., two days). Such adjustments may include increasing the size of the status indicator, replacing an image with a more noticeable image, or changing the location of the status indicator on the vehicle page to emphasize the short estimated duration of remaining availability. In further embodiments, the server 140 may generating a displayable vehicle page from the vehicle information included in the stored vehicle page, which may include the vehicle information and status indicator in a format for transmission to and display at the client computing device 110. Sending the vehicle page or displayable to the client computing device 110 may cause the client computing device 110 to display the vehicle page or displayable vehicle page to the user, including displaying the status indicator or estimate of time remaining or visual representations thereof. Upon sending the vehicle page to the client computing device 110, the method 500 may terminate.

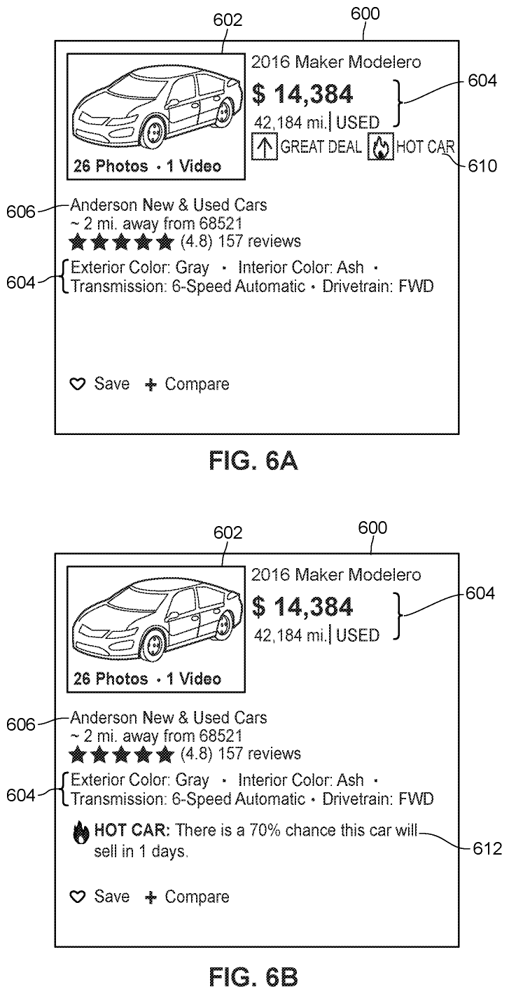

FIGS. 6A-B illustrate exemplary vehicle pages 600 having status indicators associated with expected duration of vehicle availability. The exemplary vehicle pages 600 may be presented to a user via a display 202 of a client computing device 110 to provide information regarding a vehicle offered for sale. The exemplary vehicle pages 600 may be received as corresponding data files from a server 140 in response to a user request for such information. In various embodiments, the exemplary vehicle pages 600 may be presented within a web browser or special-purpose application executing on the client computing device 110. The exemplary vehicle pages 600 are provided to illustrate example status indicators, and other arrangements having additional, alternate, or fewer elements may be used in alternative embodiments.

FIG. 6A illustrates an exemplary vehicle page 600 including an image 602 of a vehicle, as well as other vehicle characteristics 604. The other vehicle characteristics may include summary vehicle data (e.g., make, model, year, mileage, and price) and vehicle detail data (e.g., interior and exterior colors, transmission, and drivetrain). Vehicle location data 606 may also be displayed, which may include information regarding a vehicle dealer. Such vehicle information may be utilized by the user to evaluate the suitability of the vehicle for the user. In addition, the exemplary vehicle page 600 includes a status indicator 610 identifying the particular vehicle as a “Hot Car” to the user. Such status indicator 610 may include text, graphics, or a combination of both in order to provide a readily cognizable indication of the vehicle status as being in high demand. A similar status indicator 612 is shown in FIG. 6B, with the addition of an explanation of the status as indicating an estimated time remaining as a 70% chance the vehicle will sell within one day, thereby making it no longer available after such sale.

### OTHER CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

This detailed description is to be construed as exemplary only and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for system and a method for assigning mobile device data to a vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

Although the foregoing text sets forth a detailed description of numerous different embodiments, it should be understood that the legal scope of the invention is defined by the words of the claims set forth at the end of this patent. The particular features, structures, or characteristics of any specific embodiment may be combined in any suitable manner and in any suitable combination with one or more other embodiments, including the use of selected features without corresponding use of other features. It is to be understood that other variations and modifications of the embodiments of the present invention described and illustrated herein are possible in light of the teachings herein and are to be considered part of the spirit and scope of the present invention. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for the sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

What is claimed is:

1. A computer-implemented method for providing information regarding vehicle inventory availability, comprising:
receiving, at one or more processors of a server, a page generation request from a first user to post a vehicle page providing vehicle information regarding a uniquely identifiable vehicle for sale, wherein the vehicle information includes vehicle characteristics of the uniquely identifiable vehicle and a location of the uniquely identifiable vehicle;
generating, by the one or more processors of the server, an expected duration of availability of the uniquely identifiable vehicle by applying a predictive model to the vehicle information, wherein the expected duration of availability indicates a total predicted time between the page generation request and a sale of the uniquely identifiable vehicle;
determining, by the one or more processors of the server, a threshold duration based upon the vehicle information, wherein the threshold duration is either a new vehicle threshold duration associated with new vehicles or a used vehicle threshold duration associated with used vehicles;
determining, by the one or more processors of the server, that the expected duration of availability is below the threshold duration;
generating, by the one or more processors of the server, the vehicle page, wherein the vehicle page includes the vehicle information and a status indicator associated with the expected duration of availability;
receiving, at the one or more processors of the server, a page display request from a second user to obtain the vehicle page; and
transmitting, from the one or more processors of the server, the vehicle page for presentation to the second user.

2. The computer-implemented method of claim 1, further comprising:
determining, by the one or more processors of the server, a posting date on which the page generation request was received;
determining, by the one or more processors of the server, a current date on which the page display request is received; and
generating, by the one or more processors of the server, an estimate of time remaining as the difference between (i) an expected sale date determined based upon the posting date and the expected duration of availability and (ii) the current date,
wherein the status indicator includes the estimate of time remaining.

3. The computer-implemented method of claim 2, further comprising:
determining, by the one or more processors, an elapsed time since the posting date exceeds the expected duration of availability;
adjusting, by the one or more processors, the vehicle page to remove the status indicator;
receiving, at the one or more processors of the server, an additional page display request from a third user to obtain the vehicle page; and
transmitting, from the one or more processors of the server, the adjusted vehicle page for presentation to the third user, without the status indicator.

4. The computer-implemented method of claim 1, wherein the page generation request from the first user to post the vehicle page is a request to adjust at least part of corresponding vehicle information regarding the uniquely identifiable vehicle in a previously posted vehicle page.

5. The computer-implemented method of claim 1, wherein the vehicle characteristics include the following regarding the uniquely identifiable vehicle: a vehicle model, a year of manufacture, a plurality of optional vehicle features, and a price.

6. The computer-implemented method of claim 1, further comprising:
receiving, at one or more processors of an additional server, vehicle inventory data for a plurality of vehicles, wherein the vehicle inventory data includes the following for each vehicle of the plurality of vehicles: a location of the vehicle, a plurality of characteristics of the vehicle, a price of the vehicle, a listing date of the vehicle, and a sale date of the vehicle;
receiving, at the one or more processors of the additional server, an untrained model configured to predict duration of availability; and
training, by the one or more processors of the additional server, the untrained model using the vehicle inventor data to generate the predictive model.

7. The computer-implemented method of claim 6, wherein:
the listing date of the vehicle is a most recent date on which a listing for the vehicle was posted or updated; and
the sale date of the vehicle is a date on which the vehicle is inferred to have been sold based upon removal of the listing for the vehicle.

8. The computer-implemented method of claim 1, wherein:
the new vehicle threshold duration is three weeks; and
the used vehicle threshold duration is one week.

9. A computer system for providing information regarding vehicle inventory availability, comprising:
one or more processors;
a communication module adapted to communicate data via a network;
a program memory coupled to the one or more processors and storing executable instructions that, when executed by the one or more processors, cause the computer system to:
receive a page generation request via the communication module from a first user to post a vehicle page providing vehicle information regarding a uniquely identifiable vehicle for sale, wherein the vehicle information includes vehicle characteristics of the uniquely identifiable vehicle and a location of the uniquely identifiable vehicle;
generate an expected duration of availability of the uniquely identifiable vehicle by applying a predictive model to the vehicle information, wherein the expected duration of availability indicates a total predicted time between the page generation request and a sale of the uniquely identifiable vehicle;
determine a threshold duration based upon the vehicle information, wherein the threshold duration is either a new vehicle threshold duration associated with new vehicles or a used vehicle threshold duration associated with used vehicles;
determine that the expected duration of availability is below the threshold duration;
generate the vehicle page, wherein the vehicle page includes the vehicle information and a status indicator associated with the expected duration of availability;
receive a page display request via the communication module from a second user to obtain the vehicle page; and
transmit via the communication module the vehicle page for presentation to the second user.

10. The computer system of claim 9, wherein the executable instructions further cause the computer system to:
determine a posting date on which the page generation request was received;
determine a current date on which the page display request is received; and
generate an estimate of time remaining as the difference between (i) an expected sale date determined based upon the posting date and the expected duration of availability and (ii) the current date,
wherein the status indicator includes the estimate of time remaining.

11. The computer system of claim 10, wherein the executable instructions further cause the computer system to:
determine an elapsed time since the posting date exceeds the expected duration of availability;
adjust the vehicle page to remove the status indicator;
receive an additional page display request from a third user to obtain the vehicle page; and
transmit the adjusted vehicle page for presentation to the third user, without the status indicator.

12. The computer system of claim 9, wherein the page generation request from the first user to post the vehicle page is a request to adjust at least part of corresponding vehicle information regarding the uniquely identifiable vehicle in a previously posted vehicle page.

13. The computer system of claim 9, wherein the executable instructions further cause the computer system to:
receive vehicle inventory data for a plurality of vehicles, wherein the vehicle inventory data includes the following for each vehicle of the plurality of vehicles: a location of the vehicle, a plurality of characteristics of the vehicle, a price of the vehicle, a listing date of the vehicle, and a sale date of the vehicle;
receive an untrained model configured to predict duration of availability; and
train the untrained model using the vehicle inventor data to generate the predictive model.

14. The computer system of claim 13, wherein:
the listing date of the vehicle is a most recent date on which a listing for the vehicle was posted or updated; and
the sale date of the vehicle is a date on which the vehicle is inferred to have been sold based upon removal of the listing for the vehicle.

15. A tangible, non-transitory computer-readable medium storing executable instructions for providing information regarding vehicle inventory availability that, when executed by one or more processors of a computer system, cause the computer system to:
receive a page generation request from a first user to post a vehicle page providing vehicle information regarding a uniquely identifiable vehicle for sale, wherein the vehicle information includes vehicle characteristics of the uniquely identifiable vehicle and a location of the uniquely identifiable vehicle;
generate an expected duration of availability of the uniquely identifiable vehicle by applying a predictive model to the vehicle information, wherein the expected duration of availability indicates a total predicted time between the page generation request and a sale of the uniquely identifiable vehicle;
determine a threshold duration based upon the vehicle information, wherein the threshold duration is either a new vehicle threshold duration associated with new vehicles or a used vehicle threshold duration associated with used vehicles;
determine that the expected duration of availability is below the threshold duration;
generate the vehicle page, wherein the vehicle page includes the vehicle information and a status indicator associated with the expected duration of availability;
receive a page display request from a second user to obtain the vehicle page; and
transmit the vehicle page for presentation to the second user.

16. The tangible, non-transitory computer-readable medium of claim 15, further storing executable instructions that cause the computer system to:
determine a posting date on which the page generation request was received;
determine a current date on which the page display request is received; and
generate an estimate of time remaining as the difference between (i) an expected sale date determined based upon the posting date and the expected duration of availability and (ii) the current date,
wherein the status indicator includes the estimate of time remaining.

17. The tangible, non-transitory computer-readable medium of claim 16, further storing executable instructions that cause the computer system to:
determine an elapsed time since the posting date exceeds the expected duration of availability;
adjust the vehicle page to remove the status indicator;
receive an additional page display request from a third user to obtain the vehicle page; and
transmit the adjusted vehicle page for presentation to the third user, without the status indicator.

18. The tangible, non-transitory computer-readable medium of claim 15, wherein the page generation request from the first user to post the vehicle page is a request to adjust at least part of corresponding vehicle information regarding the uniquely identifiable vehicle in a previously posted vehicle page.

19. The tangible, non-transitory computer-readable medium of claim 15, further storing executable instructions that cause the computer system to:
receive vehicle inventory data for a plurality of vehicles, wherein the vehicle inventory data includes the following for each vehicle of the plurality of vehicles: a location of the vehicle, a plurality of characteristics of the vehicle, a price of the vehicle, a listing date of the vehicle, and a sale date of the vehicle;
receive an untrained model configured to predict duration of availability; and
train the untrained model using the vehicle inventor data to generate the predictive model.

20. The tangible, non-transitory computer-readable medium of claim 19, wherein:
the listing date of the vehicle is a most recent date on which a listing for the vehicle was posted or updated; and
the sale date of the vehicle is a date on which the vehicle is inferred to have been sold based upon removal of the listing for the vehicle.
